(19) United States
(12) Patent Application Publication
(10) Pub. No.: US 2005/0257257 A1
(43) Pub. Date: Nov. 17, 2005

(54) Method and apparatus for two-way transmission of medical data

(76) Inventors: Dennis O'Connor, Orford, NH (US); William McGonigle, Plainfield, NH (US); David Chen, Wrentham, MA (US)

Correspondence Address: Mark J. Pandiscio;Pandiscio & Pandiscio, P.C., 470 Totten Pond Road, Waltham, MA, 02451-1914, US

(21) Appl. No.: 10/994,730

(22) Filed: Nov. 22, 2004

Related U.S. Application Data
(60) Provisional application No. 60/524,233, filed on Nov. 21, 2003.

(51) Int. Cl. H04L 9/00; H04L 9/32; G06F 11/30; G06F 12/14

(52) U.S. Cl. 726/11

(57) ABSTRACT

The present invention utilizes standard SSH technology and the rsync and scp protocols to enable secure, cost-effective, two-way transmission of medical data over the Internet and through the hospital's firewall using push and pull mechanisms. The hospital firewall is traversed through the use of an agent located behind the hospital's firewall which uses both a push mechanism and a pull mechanism to transmit raw scan data. In other words, the present invention transfers data from the hospital to the third party by initiating a data push mechanism from behind the hospital firewall; and transfers the processed data from the outside third party back into the hospital by initiating a data pull mechanism from behind the hospital firewall. The afore-mentioned agent acts as a broker for the foregoing data transmission and also encodes how the data should be handled upon being received by the hospital.

### REFERENCE TO PENDING PRIOR PATENT APPLICATION

This patent application claims benefit of pending prior U.S. Provisional Patent Application Ser. No. 60/524,233, filed Nov. 21, 2003 by Dennis O'Connor et al. for MMS DICOM ARMORCAR PRO—METHODS FOR ENCRYPTING TWO-WAY TRANSMISSION OF MEDICAL DATA (Attorney's Docket No. MMS-28 PROV).

The above-identified patent application is hereby incorporated herein by reference.

### FIELD OF THE INVENTION

This invention relates to the two-way transmission of medical data in general, and more particularly to the HIPAA-compliant transfer of patient-specific image data between a healthcare provider and a third party.

### BACKGROUND OF THE INVENTION

The sharing of patient image data between healthcare providers (e.g., hospitals) and third parties (e.g., specialized imaging services such as Medical Metrx Solutions of West Lebanon, N.H.) presents a myriad of challenges. These challenges include privacy, expense and accessibility, among others.

In 1996, President Clinton signed the Health Insurance Portability and Accountability Act (HIPAA). Among other things, this law (i) ensures the continuity of healthcare coverage for individuals changing jobs; (ii) includes a provision that impacts the management of health information; (iii) seeks to simplify the administration of health insurance; and (iv) aims to combat waste, fraud and abuse in health insurance and healthcare.

The Department of Health and Human Services has issued various regulations to implement these new requirements. These regulations impact all healthcare organizations that electronically create, store and/or transmit healthcare data. Among other things HIPAA requires the secure storage and transmission of electronic healthcare data.

Setting up Virtual Private Networks (VPNs) or running point-to-point T1 lines can provide the necessary secure transmission of electronic healthcare data. However, VPNs and T1 lines can be cost prohibitive in many situations.

Alternatively, the so-called secure shell (SSH) technology and rsync protocol can be used to provide a suite of network connectivity tools which enable secure transmission of electronic healthcare data by creating a minimal subset of a many-to-one virtual network running over the public Internet.

In addition to the foregoing, medical institutions (e.g., hospitals) typically implement firewalls to limit outside access to their internal computer networks. Among other things, and of particular significance to the present invention, hospital firewalls will typically block outside attempts to access any medical data on their internal radiology networks.

Unfortunately, in many situations it can be important for a healthcare provider (e.g., a hospital) to share data with an outside third party (e.g., a service provider). By way of example, and of particular application to the present invention, it may be desirable to pass raw scan data from the hospital to an outside imaging service for specialized processing and return. Thus, for example, CT scan data must be transmitted from a hospital to Medical Metrx Solutions of West Lebanon, N.H. (MMS), where that CT scan data is converted into patient-specific computer models and then returned to the hospital for viewing by medical personnel. In circumstances such as these, the aforementioned security systems for storing and transmitting electronic healthcare data can impede the electronic transfer of the data.

### SUMMARY OF THE INVENTION

The present invention provides for a secure, two-way transmission of medical data over the Internet and through the hospital's firewall using push and pull mechanisms. More particularly, the present invention utilizes standard SSH technology and the rsync and scp (secure copy) protocols to enable secure, cost-effective data transmission over the Internet. The hospital firewall is traversed through the use of an agent located behind the hospital's firewall. The agent utilizes a push mechanism to push the raw scan data through the firewall and over the Internet to the outside third party; and the agent uses a pull mechanism to reach through the firewall and over the Internet to retrieve the data processed by the outside third party. In other words, the present invention transfers data from the hospital to the third party by initiating a data push mechanism from behind the hospital firewall; and transfers the processed data from the outside third party back into the hospital by initiating a data pull mechanism from behind the hospital firewall. The aforementioned agent acts as a broker for the foregoing data transmission and also encodes how the data should be handled once it is received on the hospital side.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 is a schematic view showing the transmission of DICOM data from the hospital to a third party and the retrieval of processed data from the third party back to the hospital;

FIG. 2 is a schematic view showing the transmission of DICOM data from the hospital to a third party and the retrieval of DICOM data from the third party back to the hospital; and

FIG. 3 is a schematic view showing remote 3D imaging in accordance with the present invention.

### DETAILED DESCRIPTION OF THE PREFERRED EMBODIMENTS

The Digital Imaging and Communications In Medicine (DICOM) Standard was established in 1992 and is the standard for exchanging medical images in a digital format. DICOM was initiated by the American College of Radiology to address the need for connectivity between imaging equipment.

In accordance with the present invention, there is provided the aforementioned agent, which is essentially a two-way transfer device comprising computer hardware and software for enabling the secure, cost-effective transmission of data (including DICOM data) through a hospital's firewall and across the Internet. For convenience, the aforementioned agent may hereinafter sometimes be referred to as “DAC Pro”, which is an acronym for the DICOM Armor Car Pro™ product of Medical Metrx Solutions of West Lebanon, N.H. (MMS), which constitutes one preferred implementation of the present invention.

The DAC Pro is designed to allow the secure transfer of DICOM image data over regular Internet connections without using Virtual Private Networks. The DAC Pro preferably comes pre-configured to work on the hospital network behind the firewall, and contains all of the hardware and software necessary to (i) send data across the firewall and through the Internet to a third party (e.g., MMS) for 3D processing, and (ii) retrieve the processed data (e.g., 3D patient-specific studies) back through the Internet and across the firewall for use in surgical planning by medical professionals at the hospital. Once the DAC Pro retrieves the data from MMS, it is stored for 30 days on a hard drive of the DAC Pro. The DAC Pro is not designed for long-term data storage; it is integrated into the hospital network so that data can be stored in hospital systems for long-term storage. The DAC Pro preferably runs a customized version of the Red Hat Linux operating system and boots from a CD-ROM. Preferably, all of the system software runs from the CD-ROM, and no system software needs to run from the hard drive of the DAC Pro. By having all software run from the CD-ROM, the DAC Pro has added security and is easily upgraded.

The DAC Pro resides within the healthcare institution's firewall. It pushes medical data through the firewall and over the Internet to MMS (or other third party) and/or pulls medical data back over the Internet and back through the firewall. Significantly, the third party (e.g., MMS) never sends data directly to the DAC Pro. Thus, the remote healthcare institution's firewall requires little modification and data is easily secured through encryption.

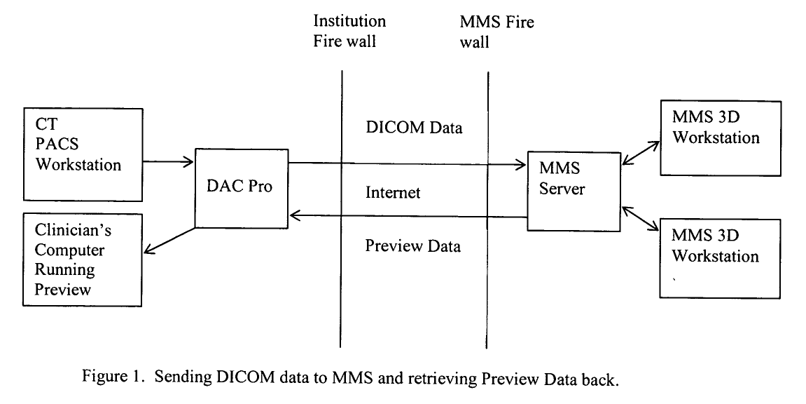

The DAC Pro can be used to transfer data in various formats. By way of example, the DAC Pro can be used to transfer DICOM data to MMS, and to retrieve 3D model data (e.g., MMS Preview® data) from MMS. See FIG. 1.

By using the DICOM standard for data transfer, the DAC Pro conforms with established radiology standards. The DICOM data is sent to the DAC Pro unit in the same manner as it would be transfered to another DICOM device within the hospital, e.g., a Picture Archiving System (PACS), a printer or a workstation. To reduce complexity, the DICOM protocol is not handled directly by the DAC Pro. Rather, protocol communications are forwarded securely by using 768-bit RSA public key authentication and 256-bit Advanced Encryption Standard (AES) data encryption through a secure shell (ssh) tunnel to a DICOM server at the third party, where the DICOM communication is handled. This ensures HIPPA compliance.

This outgoing data transmission is handled as a push through the firewall and over the Internet.

Once the DICOM data (e.g., the 2D CT slice data) arrives at MMS, MMS modeling technicians retrieve the data and create a patient-specific 3D Preview® model. Once modeling is complete, the patient-specific model is stored on a server at MMS. Preferably it is placed on the MMS server in an appropriate folder specifically set up for a particular hospital, and is preferably stored in an industry standard compressed format, e.g., single gzip'ed tar file. This single compressed file format is preferred, since it makes transfer times much faster than sending many uncompressed files.

The DAC Pro at the receiving hospital is in constant contact with the MMS server through the aforementioned ssh tunnel connection. Once the DAC Pro at the receiving hospital sees the completed study in its remote folder on the MMS server, it pulls the data back over the Internet and through the firewall to its local hard drive. At the hospital side the DAC Pro decrypts and decompresses the pulled data. The DAC Pro preferably runs a version of the Samba file server so that the data is easily available for viewing using the Preview® Planning software.

Significantly, the incoming data transmission is handled as a pull initiated from inside the firewall, which permits the data to be passed from MMS into the secure healthcare facility.

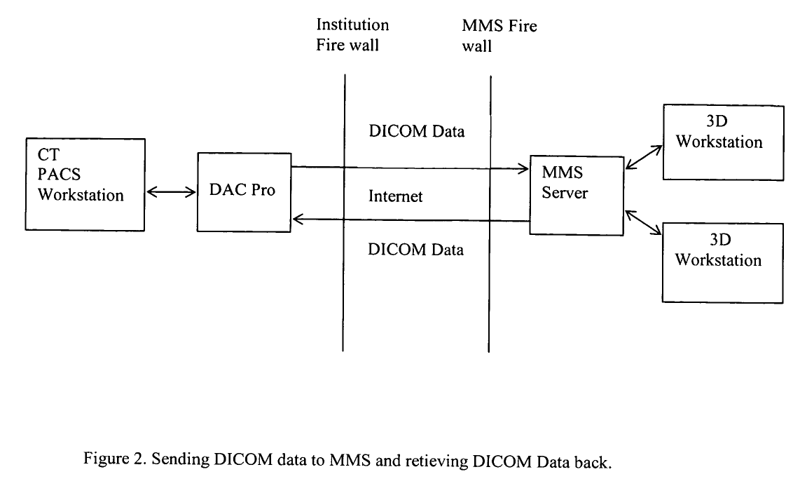

The DAC Pro can also be used to transfer DICOM data to MMS and to retrieve DICOM data back from MMS. See FIG. 2. By way of example but not limitation, the DAC Pro might send DICOM data to MMS for processing on 3D workstations using software other than the MMS Preview® software (e.g., software from Vital Images, Voxar, etc.) and then forward this processed DICOM data back to the institution's PACS system for viewing by radiologists and clinicians. More specifically, data is pushed to MMS with the same security measures described above. Technicians at MMS, using 3^{rd} party workstations, query the MMS DICOM server to retrieve the patient data. 3D image rendering is then effected by MMS technicians using the 3^{rd} party workstations. Once the 3D rendering is complete, the technicians need to return the processed DICOM data from their workstations to the sending institution. In this scenario, the data is first sent to the MMS DICOM server and placed in a separate directory based upon the receiving institutions DICOM AE TITLE (the AE Title is a unique identifier in the DICOM realm). The data in this directory is gzip'ed and tar'ed as described previously. However, this time the data has additional information pertaining to the receiving institution's PACS encoded in it. Again, the DAC Pro located inside the firewall at the remote site pulls the processed DICOM data from the MMS server once it sees data in its specific directory. This processed DICOM data is pulled over the Internet and through the firewall to the DAC Pro unit located at the remote site. With the encoded information and a trigger in the file name, the DAC Pro will know that this is DICOM data and not Preview® data. The DAC Pro will then use the AE Title, IP Address, and port number it retrieves and send the DICOM data to the hospital's PACS. Once on the hospital's PACS, the data is available to all clinicians who have access to the PACS.

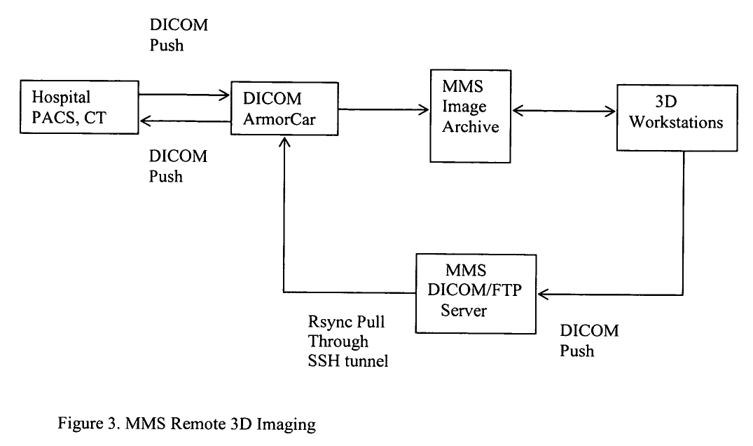

Looking next at FIG. 3, the remote hospital acts as an SCU to send data to the DAC Pro, which then forwards the data, using a push transfer, through the firewall and then across an ssh tunnel established over the Internet to the MMS server. Upon arriving at the MMS Image Archive server, the 3D workstations query the server for studies which need processing (preferably utilizing the DICOM general purpose worklist). Once the studies are complete, the 3D workstations act as an SCU to send the completed studies to the MMS outgoing DICOM server. This server receives the DICOM data and does the work of creating the gzip'ed tar file. The gzip'ed tar file is then transferred to an ftp “drop box” that is unique for the receiving institution. The DAC Pros located at their respective remote institutions are continually polling their respective “drop boxes” at the MMS server for data to retrieve. Once it is determined that there is data in the “drop box”, the DAC Pro pulls the data, using rsync or scp through a new ssh tunnel, to bring the data back over the Internet and through the firewall. Upon arriving at the DAC Pro, the DAC Pro uses the pre-configured information pertaining to that hospital's PACS (IP Address, port, and AE Title) to act as an SCU to push the data to the hospital's PACS. This is all completed using ssh connections over the Internet. All data is pushed to MMS, or pulled from MMS, from within the sending institution's firewall, keeping the data secure at all times.

The ssh tunnel can be established with an appropriate command such as:
/usr/bin/ssh -F ssh_config dicom.medicalmedia.com -q -N
   where the file ssh_config points to the MMS Image Archive.
   Host *
   Port 22
   LocalForward 104 imagearchive.medicalmedia.com:104
   User mms_customer

It will be understood that many changes in the details, materials, steps and arrangements of elements, which have been herein described and illustrated in order to explain the nature of the invention, may be made by those skilled in the art without departing from the scope of the present invention.

1. An agent for transmitting data between a first site and a second site, wherein the first site and the second site are connected to the Internet, and further wherein the first site is located behind a firewall;
said agent being located behind said firewall and being connected to first site and to the Internet, said agent comprising first, second and third components;
said first component being configured for receiving data from said first site;
said second component being configured for pushing data through said firewall and over the Internet to said second site; and
said third component being configured for pulling data over the Internet and through said firewall from said second site and for holding the pulled data for access by said first site.

2. An agent according to claim 1 wherein said second component is configured to push DICOM data through said firewall and over the Internet to said second site.

3. An agent according to claim 1 wherein said third component is configured to pull non-DICOM data through said firewall and over the Internet to said second site.

4. An agent according to claim 1 wherein said third component is configured to pull DICOM data through said firewall and over the Internet to said second site.

5. An agent according to claim 1 wherein said data is pushed and pulled using an ssh tunnel.

6. An agent according to claim 1 wherein said data is pushed and pulled using either an rsync or scp protocol.

7. An agent according to claim 1 wherein said data is encrypted prior to pushing through said firewall.

8. An agent according to claim 1 wherein said data is decrypted after pulling through said firewall.

9. An agent according to claim 1 wherein said data is compressed prior to pushing through said firewall.

10. An agent according to claim 1 wherein said data is decompressed after pulling through said firewall.

11. A system comprising:
a first site and a second site, wherein the first site and the second site are connected to the Internet, and further wherein the first site is located behind a firewall;
an agent for transmitting data between said first site and said second site, said agent being located behind said firewall and being connected to first site and to the Internet, said agent comprising first, second and third components;
said first component being configured for receiving data from said first site;
said second component being configured for pushing data through said firewall and over the Internet to said second site; and
said third component being configured for pulling data over the Internet and through said firewall from said second site and for holding the pulled data for access by said first site.

12. A method for transmitting data between a first site and a second site, wherein the first site and the second site are connected to the Internet, and further wherein the first site is located behind a firewall;
receiving data from said first site;
pushing data through said firewall and over the Internet to said second site; and
pulling data over the Internet and through said firewall from said second site and for holding the pulled data for access by said first site.
